(19) United States
(12) Patent Application Publication
(10) Pub. No.: US 2004/0254890 A1
(43) Pub. Date: Dec. 16, 2004

(54) System method and apparatus for preventing fraudulent transactions

(76) Inventors: Enrique David Sancho, Yaacov (IL); Kenneth Bob, Woodbury, NY (US)

Correspondence Address: Thomas A. O'Rourke, Bodner & O'Rourke, 425 Broadhollow Road, Melville, NY, 11747, US

(21) Appl. No.: 10/444,506

(22) Filed: May 23, 2003

Related U.S. Application Data
(60) Provisional application No. 60/382,959, filed on May 24, 2002.

(51) Int. Cl. G06F 17/60

(52) U.S. Cl. 705/67

(57) ABSTRACT

The present invention is directed to an improved security system, method and apparatus for reducing recurring fraudulent activity from a particular location. The present invention uses a non-intrusive process that registers and uniquely identifies each location using a digital fingerprint. When fraudulent use is encountered, the associated location is flagged in a database and the associated location is prevented from completing the transaction.

The present application claims priority on U.S. application Ser. No. 09/875,795 filed Jun. 6, 2001. The present application also claims the priority on WO 01/09756, PCT/US00/21058 filed Jul. 31, 2000 and the following US patent applications: U.S. application Ser. No. 09/523,902, filed Mar. 13, 2000, which is a continuation in part of U.S. application Ser. No. 09/500,601, filed February 8, 2000 and claims the benefit of priority to U.S. Provisional application Ser. No. 60/167,352, filed Nov. 24, 1999 and U.S. Provisional application Ser. No. 60/146,628, filed Jul. 30, 1999. The specifications of these applications are hereby incorporated herein by reference in their entireties.

### FIELD OF THE INVENTION

The present invention relates to improvements in the security of transactions from a remote location through the use of a computer system. The present invention has particular applicability in a transaction performed over a network such as the Internet.

### BACKGROUND OF THE INVENTION

In recent years, more and more commercial activity is being performed through the use of computers over a network. These transactions can include purchases of goods and services, banking activity, brokerage transactions, etc. Network commercial activity often involves dealing with remote locations where the user is known only to the purchaser by a designation such as an account number and/or a password or other identification means. Thus, a user in one location can access a provider or source in a different location. These transactions can include a variety of activities from the purchase of goods and services, accessing information or data etc. These transactions can be performed over a LAN, a WAN, an intranet, the Internet or other suitable network.

One of the problems that has arisen is the issue of security. Unfortunately, fraudulent transactions are on the increase. Many transactions can involve large sums of money, goods, services or information. As a result, there is a need for the provider or source to have assurances as to the bona fides of the user. While there is a great deal of interest in biological identification such as eye scans and fingerprints, the cost of these devices are generally prohibitive in view of the huge number of locations that must be provided with this equipment. Another approach that has been used in the past has been the use of a password or secret code known only to appropriate user. Unfortunately, this is not a very secure way of operating. Passwords can be lost, stolen, and or even hacked. If forgotten, the user can contact the supplier or other repository for this information and obtain a replacement over the phone. Providers are in a very difficult position in these instances where a password has been forgotten. On the one hand, there is a desire for the provider to supply a replacement password so that a transaction may be entered into. On the other hand, there is an increase in the security risk since the desire to complete the transaction is very strong an effort is frequently made to provide the user with the ability to complete the transaction using a lesser level of security. Thus, the provider frequently asks the user pre-selected personal questions that the provider believes that only the proper user would know. Unfortunately, the information sought by the provider is frequently commonly available information such as a mother's maiden name, social security number, or the identity of other persons on the account.

Another problem that is frequently encountered is the issue of identity theft. A stolen, lost or misplaced wallet can provide an individual with the means to misappropriate the owners identity. Thus, new credit card accounts may be opened and other activity may occur where the provider believes that the user is legitimately the person identified in the application. Since the owner of the wallet did not open the account the credit card company or other provider may have no recourse in attempting to recover the loss. There are also a number of other types of fraudulent activities that can be performed using a public or private network that can create serious losses to the providers of the goods, services or other products. In the case where a gas station attendant, or waiter in a restaurant uses a customer's credit card number and expiration date to purchase over the Internet is another case of a fraudulent transaction.

In analyzing the fraudulent transactions that occur, it has been found that typically a fraudulent transaction is not an isolated instance. More often than not, the fraudulent conduct is part of a pattern by the perpetrator that includes multiple instances of fraudulent conduct. For example, in a study conducted by Experian, Gartner reported 40% of Internet retailers were hit several times by the same perpetrator. Accordingly, there is a need for a means of reducing the amount of repeat fraudulent activity that can performed.

### OBJECTS OF THE INVENTION

It is an object of the invention to provide a system method and/or apparatus that can reduce the instances of repeated fraudulent activity at a given location by the same perpetrator.

It is also an object of the invention to provide a means for identifying locations where fraudulent activity occurs to prevent repeat acts of fraud.

It is a further object of the invention to provide a means for developing a fingerprint of a location so that if fraudulent activity occurs the location can be reliably identified and future fraudulent activity from that location can be prevented.

It is a further object of the invention to provide a means for developing a fingerprint of a computer such as a PC, a laptop or a server so that if fraudulent activity occurs the location can be reliably identified and future fraudulent activity from that computer can be prevented.

It is a further object of the invention to provide a means for developing a fingerprint of a PDA so that if fraudulent activity occurs the location can be reliably identified and future fraudulent activity from that PDA can be prevented.

It is a further object of the invention to provide a means for developing a fingerprint of a cell phone so that if fraudulent activity occurs the location can be reliably identified and future fraudulent activity from that cell phone can be prevented.

It is a further object of the invention to provide a means for developing a fingerprint of a device having an Internet connection so that if fraudulent activity occurs the location can be reliably identified and future fraudulent activity from that device can be prevented.

It is a still further object of the invention to provide a means for taking a fingerprint of a location from which a transaction is requested and comparing it to a data base of fingerprints from other locations where fraudulent activity has occurred in the past.

It is a still further object of the invention to provide a means for taking a fingerprint of a computer including a PC, a laptop or a server from which a transaction is requested and comparing it to a data base of fingerprints from other computers where fraudulent activity has occurred in the past.

It is a still further object of the invention to provide a means for taking a fingerprint of a PDA from which a transaction is requested and comparing it to a data base of fingerprints from other PDA's where fraudulent activity has occurred in the past.

It is a still further object of the invention to provide a means for taking a fingerprint of a cell phone from which a transaction is requested and comparing it to a data base of fingerprints from other cell phones where fraudulent activity has occurred in the past.

It is a still further object of the invention to provide a means for taking a fingerprint of a device having an Internet connection from which a transaction is requested and comparing it to a data base of fingerprints from other such devices where fraudulent activity has occurred in the past.

It is an object of the invention to provide a means where a system that has a fingerprint that has been identified as a location where fraudulent activity has occurred in the past can be precluded from entering into certain transactions.

### SUMMARY OF THE INVENTION

The present invention is directed to an improved security system, method and apparatus for reducing recurring fraudulent activity from a particular location. The present invention protects payment providers, processors, and eMerchants from revenue loss caused by repeat fraud. To prevent repeat fraud, the present invention uses a non-intrusive process that registers and uniquely identifies each location using a digital fingerprint. When illegitimate or fraudulent use is encountered, the associated location is flagged in a database and the associated location is prevented from completing the transaction. One of the advantages of the present invention is that it maintains customer satisfaction with the online experience. The present invention is easy to use, implement, and maintain. Thus, lock-out protection from fraudster PCs is achieved before repeat fraud strikes. As used herein, the term location refers to any computer including but not limited to PC's, laptops, servers and others; PDA's, cell phones and devices having an Internet or other network connection.

In its broadest sense, a provider receives a request from a user station. The user station can be a computer, a terminal or other device that is connected to a network. In response to the request from the user, the provider, either directly or someone operating under the provider's authority, takes a fingerprint of the device that is the source of the request. Where, for example, the user device is a computer the fingerprint can include such designations as serial number, identifications on components, component configurations and the like. Similar information can constitute the fingerprint on other devices. The fingerprint is stored by the provider. The term provider can include the supplier of the goods or services or other items sought by the user or can be the source of credit or other payment means. The provider processes the transaction by determining whether the user who is submitting the request is bona fide. Upon receiving information that the user is bona fide, the provider makes a decision whether to complete the transaction or to decline it. If the transaction is processed to completion, the provider makes the goods, services etc. available to the user in response to the request. In the event the provider subsequently learns that the payment or other relevant information of the user is false, that information is stored in conjunction with the previously obtained fingerprint. If a user request arrives from a device having the same fingerprint as the fingerprint of a device that was the source of improper transactions the provider may refuse to permit the transaction to be completed. This refusal may be based solely on the fingerprint information and need not be based on payment information. Thus, a second user submitting a request from a device having the same fingerprint as the device that previously had an improper transaction performed on it may have its transaction declined even though the second user's credit or payment information is unblemished. The use of the fingerprint eliminates fraudulent transactions from devices that are a source, for whatever reason, of improper transactions. Thus for example, a request from a device in a public location that is used by a number of people one or more of whom have generated improper transactions in the past may be refused or scrutinized more carefully before completion of the transaction.

### BRIEF DESCRIPTION OF THE DRAWINGS

FIG. 1 shows a user computer in communication with a provider server via the authentication server, wherein user computer is initiating a purchase transaction;

FIG. 2 shows the provider server communicating with the authentication server to request authorization to complete user's requested transaction;

FIG. 3 shows the authentication server communicating with the user's computer to check the fingerprint of the user's computer against the authentication server's database of fraudulent computers;

FIG. 4 shows the authentication server communicating to the provider that the fingerprint is not on the disabled list;

FIG. 5 shows the relationship of the user's computer, authentication server and the provider's server.

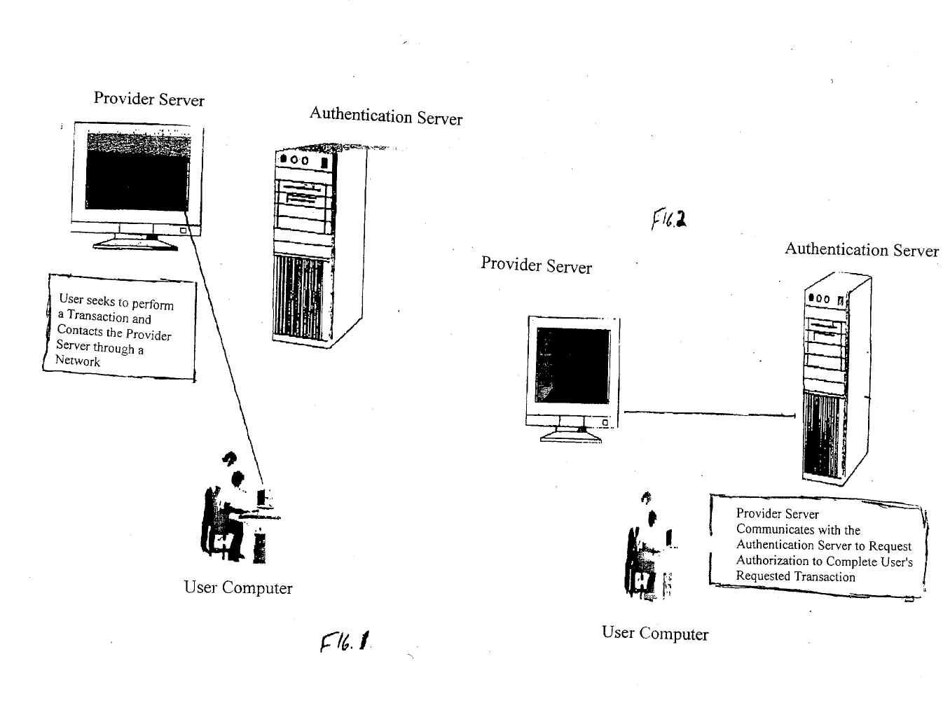

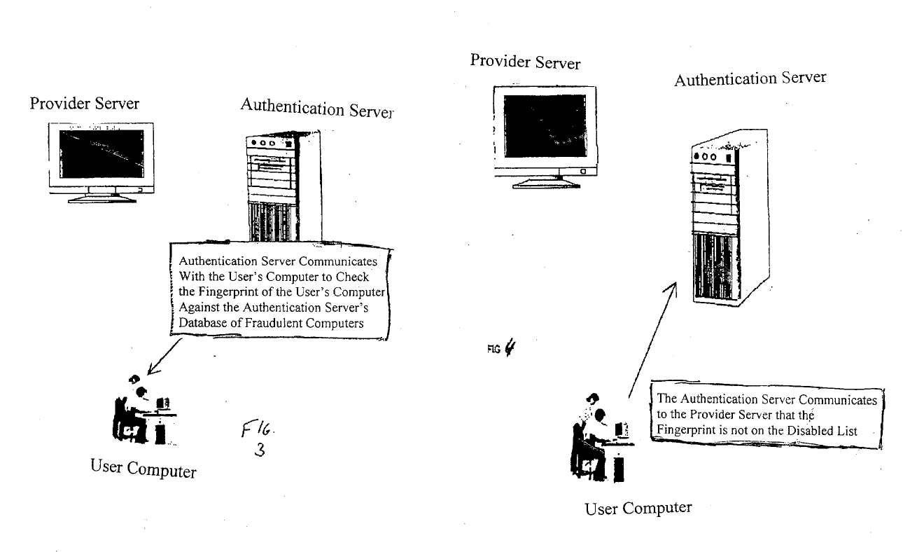

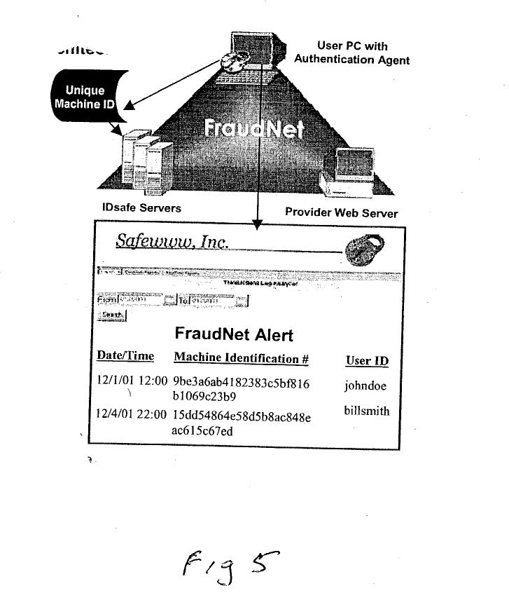

### DETAILED DESCRIPTION OF THE INVENTION

Many devices today have unique hardware fingerprints. For example, the identity of the processor, its type and clock speed, the hard drive manufacturer, the size of the hard drive, the amount of Ram, etc., all combine to make each device relatively unique. Other devices have similar fingerprints or can be provided with such relatively easily. These products include cell phones, PDA's televisions web accessing apparatus and other devices commonly available. These fingerprints can be combined with a user identifying code so that a purveyor of goods or services can have increased assurance of the bona fides of the person using this equipment to buy these goods and service or access information. These devices including computers/servers are linked by a variety of communications lines including telephone lines, cable television lines, satellite link-ups a wireless network and the like.

The fingerprint used in the present invention can be of the device's hardware, software or other attributes and combinations thereof. The fingerprint can be taken each time the provider is contacted and compared to an earlier fingerprint if one exists on the authentication server.

The exemplary embodiments assume the following typical arrangement of the parties to a transaction:

[a] a user is connected via his PC or client to a network such as the Internet through telephone, cable TV, satellite or data lines, usually through a modem and the user's client PC has installed therein an authentication program that takes a fingerprint of the user's computer or other device. Typically, the authentication program is activated by the user prior to the transaction;

[b] a provider or vendor has a server in communication with the Internet which is accessible to the user's device for the purpose of entering into a transaction,

[c] the provider's server contacts an authentication server and instructs the authentication server to obtain a fingerprint of the user's device;

[d] upon receiving the fingerprint from the user's device the authentication server checks the fingerprint information in its database to ascertain whether the user's computer is a disabled device or an appropriate device to complete a transaction;

[e] either during the fingerprint check or before or after, the purchase information of the user is checked to determine whether the user is sufficiently creditworthy to enter into the transaction.

[f] once the fingerprint has been checked and the monetary portion of the transaction has been completed the transaction is completed and the user can receive the goods, services etc. in the appropriate manner, i.e, downloading, shipping and others.

It should be understood that reference to a client or PC expressly includes any browser-equipped telecommunications device which gives the user the ability to access and interface with remote servers, and in particular Web sites on the Internet. Thus, such devices include browser-equipped cellular phones, personal digital assistants, palm held computers, laptop computers, and desktop PCs, though not exclusively. It should also be recognized that the authentication server shown herein as a separate server can also be a part of the provider's server and need not be an actual separate server.

The payment function may be accomplished by the vendor server, a separate creditor server or a combination authentication server creditor server. In the combination creditor server authentication server the authentication server performs the functions of authentication and payment. The creditor server is provided with programming directing it how to respond to the request from a vendor server for payment on a transaction.

Although the above discussion has been primarily focusing on the purchase of goods and/or services, the present invention is not so limited. As noted above, rather than being a vendor of merchandise, vendor might simply be a provider of an information or financial service. Thus vendor might be using the present invention to ensure that access to secured databases is only to properly authorized and duly-identified persons. For example, a bank might want identity verification before permitting a customer access to his account information or to use financial services. As another example, a large corporation might use the present invention to give third-party verification of an employee's or outside contractor's identity before permitting them access to secured databases which might not otherwise be available via the Internet.

Additionally, it should be noted here that, rather than being a vendor of merchandise, vendor might simply be a provider of an information or financial service, as example. Thus vendor might be using the present invention to ensure that access to secured databases is only to properly authorized and duly-identified persons. All of the components of the system may also employ a combination of security measures, for instance, all transmissions preferably take place in an encrypted environment, such as RSA, Triple DES, etc., using encryption tables which are replaceable by the security server or by a central system administrator server at random intervals.

As seen in FIG. 5, the architecture of the present invention may be depicted as a triangle. At one apex of the triangle there is the user's input device which may be a PC or other similar device for accessing a network. The user machine has a unique machine ID or fingerprint. Preferably, this fingerprint may be generated using a software program which has been designated as the Client Authentication Agent. At one corner of the triangle's base there is an authentication server that may be used to compare the user fingerprint ID when a transaction is requested by the user's machine. On the opposite side of the triangle's base is a provider web server. The provider web server or Provider Web-Based Host System receives authorization from the authentication server after the authentication server has checked the fingerprint of the user's machine.

In one embodiment of the present invention the Consumer registers at eMerchant, payment provider, or processor web site and receives a transparent one-time download of an Authentication Agent (AA). The AA creates a digital fingerprint of the Consumer's PC and sends it to the IDsafe Server. When fraud is encountered, the associated Consumer's PC is set to Disabled in the Provider's database. If future registration attempts from the Disabled PC are made, the IDsafe Server sends a report alert to the Provider. Thus the present invention prevents all future attempts of repeat fraud from the same machine.

In another embodiment of the invention, the following procedure may take place:

1) An authentication agent (AA) in the user's computer sends messages, preferably simultaneous to vendor server and the authentication server.

2) In the present embodiment the AA is a COM object which creates a “digital fingerprint” consisting of various identifying hardware characteristics which it collects from for example, the user's PC or other device used by the user in requesting a transaction. This fingerprint may also include passwords if desired. Activation of the account initiates a process by which the Authentication server records a fingerprint for the user, which the AA has derived, which may include a unique identification (“UID”) for the user, using the identifying characteristics of user's device (e.g CPU ID number, hard disk serial number, amount of RAM. BIOS version and type, etc—).

3) When a transaction starts, the user's AA, which is a simple DLL, is activated by the vendor script. The AA sends a message to the authentication server requesting authentication of the user's fingerprint. This message may be sent using the server's public key. If the authentication server answers the AA, the user's computer knows that it is talking to the correct server, since only the proper authentication server has the private key that can decrypt the message sent with its public key. The authentication server can now sends the user half of a new Triple DES key that it has generated so that the home user can communicate with it securely. Once fraud is detected the provider will disable both the login username as well as the PC or Machine for that Digital Fingerprint associated with that username. If the fraudster attempts to try to commit fraud a second time, he will be unable to success since both his username and machine have been disabled. Even if the fraudster attempts to re-register using a new set of stolen credentials (name, address, SS#, etc.) he will be blocked since his Digital Fingerprint of his machine has already been determined to be one causing fraud and has been disabled from re-registering. When registering, a simple DLL loads itself into memory, and calls a “smart” DLL, from a collection of thousands of continuously regenerated smart DLL's, which collects a large number of different parameters, for example 12, identifying the user's computer. A simple example of an authentication transaction is now described using two machine parameters. The DLL applies an algorithm such that ff the disk serial number is 1 and is multiplied by 1; and if the CPU serial number is 2 and is multiplied by 2, the resulting string is their sum or “5”. Thus, 1(1); 2(2)=5. This information is hashed by the DLL according to that DLL's hashing programming, then encrypted, and the encrypted hash is sent back to the authentication server. The order of the parameters and the algorithm used can change each time. Furthermore, the actual information is further interspersed with “garbage” code, expected by the authentication server, every time. The server receives the hashed and encrypted result from the smart DLL, and compares it to the result which it expects to receive. This is done by the authentication server by calculating the expected result by running it's own copy of the unique DLL on the user's identifying parameters that it has stored in the database. It then hashes the result, and compares its hash to the de-encrypted hash string it received from the user. One embodiment of the present invention, more specifically uses a 2048 bit RSA key to initiate the handshake, and thereafter moves to Triple DES encryption. The Public Key is distributed to all the end-users with the Agent and the Private Key(s) are held by the AA Server There is a different set of Keys for different Providers, i.e., Credit Card Companies, Banks, etc.

It will be appreciated by those skilled in the art that the teachings of the present invention can be used in a variety of different types of transactions. These transactions include:

Banking and Financial Services

A bank or financial institution can use digital fingerprints to monitor use of locations by users to prevent repeat instances of fraud or other improper activity. The fingerprint can be used as a means to prevent unauthorized stock transactions and improper access to a user's account.

Retail

One of the problems encountered in the retail business is fraudulent credit card use to purchase goods and services over the Internet using a stolen or misappropriated credit card. One common fraudulent transaction is identity theft where using personal information of a third party a user can assume the identity of the third party and obtain instant credit. With the credit a user can readily make purchases in the user's name without the user learning of it until too late. Using the fingerprint of the present invention repeat fraudulent transactions from a give location are eliminated.

Debit Card Transactions

Currently, when someone wants to purchase something on the Internet they go to an e-commerce website and enter their personal credit card information. This information then gets sent to both the eMerchant and the card-issuing bank to verify that the customer has sufficient funds to make the purchase. Although this process checks to make sure the customer has sufficient funds, what it does not check is the card owner's identity to ensure that he is the one who is really making the purchase. This is where the present invention has significant advantages. One aspect of debit card transactions is similar to credit card purchases of goods and services as discussed above. The present invention has applicability in these types of debit card transactions in the same manner as credit card transactions. Then there are transactions at locations where a banking function is performed. In those instances payments can be made and financial products such as securities may be secured. The present invention reduces the risk of unauthorized transactions in these instances.

Cell Phone Commerce

In many areas cell phones are being used to charge goods and services just like the traditional credit card. This makes the cell phones very convenient but does raise some security problems. One of the problems with the use of cell phones is their memory. Most phones that are currently in use today display the most recent numbers inputted into the phone. These numbers may be as innocent as a telephone number but can also include account numbers and passwords. In addition, there are unscrupulous persons who can clone cell phone numbers when a user is in the vicinity. The present invention may also be used to perform secure transactions with a cell phone and avoid these security issues. A user of the present invention can add a cellular phone to the system. The system can be used to ascertain whether the person on the cellular phone is an authorized user. In this embodiment, the user connects to a merchant in order to make a purchase. The server sends an SMS message to the cell phone user that will ask the user to complete the message with the appropriate code. Both the illegal clone and the user's phone will receive the request for the code. The user knowing that he did not seek to make a purchase can respond with an appropriate message to terminate the purchase.

Alternatively, a fingerprint of the cell phone that is being added to the system is created. When a purchase is being made, the vendor sends the SMS message and the user must respond the code that has been entered. The vendor's server checks the code for accuracy and the fingerprint as well and if appropriate, sends to the cell phone user a one time pass word. The one time password combined with the user's pin number acts as a signature for the purchase of goods or services using the cell phone.

In many areas cell phones are being used to charge goods and services just like the traditional credit card. This makes the cell phones very convenient but does raise some security problems. One of the problems with the use of cell phones is their memory. Most phones that are currently in use today display the most recent numbers inputted into the phone. These numbers may be as innocent as a telephone number but can also include account numbers and passwords. In addition, there are unscrupulous persons who can clone cell phone numbers when a user is in the vicinity. The present invention may also be used to perform secure transactions with a cell phone and avoid these security issues. A user of the present invention can add a cellular phone to the system. The system can be used to ascertain whether the person on the cellular phone is an authorized user. In this embodiment, the user connects to a merchant in order to make a purchase. The server sends an SMS message to the cell phone user that will ask the user to complete the message with the appropriate code. Both the illegal clone and the user's phone will receive the request for the code. The user knowing that he did not seek to make a purchase can respond with an appropriate message to terminate the purchase.

Alternatively, a fingerprint of the cell phone that is being added to the system is created. When a purchase is being made, the vendor sends the SMS message and the user must respond the code that has been entered. The vendor's server checks the code for accuracy and the fingerprint as well and if appropriate, sends to the cell phone user a one time pass word. The one time password combined with the user's pin number acts as a signature for the purchase of goods or services using the cell phone.

Pay-Per-View Television

The present invention also has applicability in the field of television. Currently many cable companies and satellite television providers are using “Smart Card” type technology to restrict the viewer to programs and/or services that have been paid for. The user purchases a Smart Card from the service provider and inserts the card into the descrambler at home. As the cost of cable and satellite television programs increases there is a need to prevent users of cable systems and satellite television services from using the television set top box with more than one television and to prevent the user from loaning or giving the descrambler and smart card to a friend or relative for their use. The present invention permits the fingerprint of the television set to be ascertained and will cause the descrambler to be inoperative if the user does not have the proper television connected to the descrambler.

What is claimed is:

1. An authentication program for securing a user station identity for a transaction over a computer network, the program comprising:
a user station connected to a computer network;
a fingerprint of the user station;
an authentication database that compares the fingerprint of the user station to other fingerprints which have been associated with fraudulent transactions; and
a provider station that receives the comparison.

2. An authentication program as in claim 1 wherein the user station is a device selected from the group consisting of a personal computer, a laptop, a cellular phone, a personal digital assistant, a satellite-enabled pager, and a television with web-browsing capability.

3. An authentication program as in claim 1 wherein the fingerprint is a hardware identity of the user station.

4. An authentication program as in claim 3, wherein the hardware identity is a processor manufacturer of the user station.

5. An authentication program as in claim 3, wherein the hardware identity is an amount of random access memory available on the user station.

6. An authentication program as in claim 1, wherein the provider station is a server of a vendor.

7. A method of preventing fraudulent transactions over a computer network comprising:
establishing a connection by a user station with the computer network;
initiating a transaction with a provider station over the network;
generating a digital fingerprint of the user station;
comparing the fingerprint of the user station with a database of fingerprints used in fraudulent transactions; and
sending the comparison to the provider station.

8. A method as in claim 7 wherein the user station is a device selected from the group consisting of a personal computer, a laptop, a cellular phone, a personal digital assistant, a satellite-enabled pager, and a television with web-browsing capabilities.

9. A method as in claim 7 wherein the digital fingerprint is a processor manufacturer of the user station.

10. A method as in claim 7 wherein the digital fingerprint is an amount of random access memory available on the user station.

11. A method as in claim 7 wherein the digital fingerprint is encrypted.

12. A method for conducting secure transactions over a computer network comprising:
recording a fingerprint by an authentication agent from a user station;
encrypting the fingerprint;
sending the encrypted fingerprint to an authentication server;
decrypting the fingerprint;
initiating a secured communication link between the user station and a vendor server; and
conducting a transaction over the link.

13. A method as in claim 12, wherein the authentication agent is a COM object.

14. A system as in claim 12, wherein the authentication agent is a dynamic-link library.

15. A method as in claim 12, wherein the fingerprint is a hardware characteristic of the user station.

16. A system for conducting secure transactions over a computer network, the system comprising:
a server adapted to communicate with a user station;
a fingerprint of the user station, whereby the server reads the fingerprints; and,
a database maintained by the server for detecting fraudulent transactions associated with the fingerprint.

17. A system for conducting secure transactions over a computer network, the system comprising:
a vendor server adopted to communicate with an authentication server and a user station;
a fingerprint from the user station obtained by the vendor server, whereby the vendor server transmits the fingerprint to the authentication server; and,
a report from the authentication server about fraudulent conduct associated with the fingerprint.
